(19) United States
(12) Patent Application Publication
(10) Pub. No.: US 2006/0262014 A1
(43) Pub. Date: Nov. 23, 2006

(54) Radio beacon, mobile station, processor, system and method for determining location

(76) Inventors: Yaron Shemesh, Kfar Yona (IL); Mihael S. Bercovici, Shoham (IL); Charles Swope, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/130,652

(22) Filed: May 17, 2005

(51) Int. Cl. G01S 1/08

(52) U.S. Cl. 342/386

(57) ABSTRACT

A radio beacon (105(5)) is for use in location determination inside a building (103) or other enclosure. The beacon transmits a RF signal equivalent to a partially coded GPS (Global Positioning System) signal which includes an identity code identifying the beacon but null data in at least one GPS data field.

A mobile station (101) includes a GPS receiver (208) for receiving GPS signals and a processor (202) for processing data extracted from signals received by the GPS receiver. The GPS receiver is operable to receive a signal from a transmitting beacon (105(5)). The processor is operable to recognise a beacon identity code from the data extracted from the received signal and thereby detect that the signal is from a radio beacon rather than a GPS satellite and thereby to apply a further procedure to calculate the location of the mobile station based upon a known location of the identified beacon.

### FIELD OF THE INVENTION

The present invention relates to a radio beacon, a mobile station, a processor, a system and a method for determining location. In particular, the invention relates to determination of location inside a building or other enclosure.

### BACKGROUND OF THE INVENTION

Technologies for determining location or position of a mobile station, e.g. a mobile radio or telephone, are now well developed in outdoor applications particularly by use of the Global Positioning System (GPS). There is a strong demand for a technology for corresponding use in determining location of mobile stations inside a building. Such technology could for example be especially useful to emergency services such as the fire service and the police to be able to locate personnel accurately within a building, particularly a multi-storey building or a large underground facility such as a mine. Much work has been carried out recently to find a suitable in-building location technology and several extensive developments have been reported. However, none of these developments provides a suitably inexpensive solution which shows satisfactory performance. In particular, no suitably inexpensive GPS based solution has been proposed.

For example, one of the systems which has been proposed includes use of specially coded radio beacons within a building. The transmitters of these beacons and especially the receivers of all mobile stations which have to be fitted to pick up the received signals from the beacons have to operate according to a specially designed communication protocol and the system is therefore unduly expensive to design and produce.

Another system which has been proposed is based on use of radio beacons known as ‘pseudolites’ which are pseudo GPS transmitters. These devices are loaded to transmit all of the data in the data fields included in GPS signals so that a GPS receiver which receives the signals from these beacons processes the information extracted from the signals in the same way that it would process signals from a set of GPS satellites. The receivers used in such a system may be commercially available GPS receivers, thereby allowing the additional cost (compared with the cost of commercially available GPS receivers) of designing and producing special receivers to be avoided. However, the radio beacons which are employed to mimic the GPS satellites are complex to design and expensive to produce and signals from several beacons at a time need to be picked up by a single receiver for the system to work in the same way as the GPS (described later).

### SUMMARY OF THE INVENTION

According to the present invention in a first aspect there is provided a radio beacon as defined in claim 1 of the accompanying claims.

According to the present invention in a second aspect there is provided a system as defined in claim 5 of the accompanying claims.

According to the present invention in a third aspect there is provided a mobile station as defined in claim 9 of the accompanying claims.

According to the present invention in a fourth aspect there is provided a processor as defined in claim 21 of the accompanying claims.

According to the present invention in a fifth aspect there is provided a method for use in the determination of location of a mobile station, the method being as defined in claim 22 of the accompanying claims.

Further features of the invention are as defined in the accompanying dependent claims and are disclosed in the description of embodiments of the invention which follow.

Embodiments of the present invention will now be described by way of example with reference to the accompanying drawings, in which:

### BRIEF DESCRIPTION OF THE DRAWINGS

FIG. 1 is a diagram showing a schematic layout of a system embodying the invention for determining location of a mobile station within a large building.

FIG. 2 is a block schematic diagram showing more detail of a mobile station shown in the system of FIG. 1.

FIG. 3 is a flowsheet showing a sub-routine or procedure operated by a processor of the mobile station shown in FIG. 2.

### DESCRIPTION OF EMBODIMENTS OF THE INVENTION

In embodiments of the invention to be described, in-building radio beacons are employed as in the known developments mentioned earlier. The beacons are again adapted to transmit a signal which can be picked up by a commercially available GPS receiver, but the beacons are designed to be much less expensive than those proposed for use in the pseudolite system of the prior art mentioned earlier. Also, the receiving MS applies new processing steps to the data received. In order to understand operation of these new beacons and the receiving MSs, it is useful first of all to review operation of the existing GPS satellite location system, as follows.

GPS (Global Positioning System) is a satellite location system which has been funded by and is controlled by the U.S. Department of Defense (DOD) but which may be used in non-military applications. The GPS consists of three building blocks: the Space Segment, the User Segment and the Control Segment. The Space Segment consists of the GPS satellites. The User Segment consists of the user GPS receivers. The Control Segment consists of installations on earth that monitor the signals from the satellites and transmit modification information to be used by the satellites as small changes occur in the satellite orbits and in the nature of the Ionosphere etc. The Control Segment also monitors atomic clocks on board the satellites and transmits corrections for these and other parameters necessary to maintain the accuracy of the system.

The GPS satellites send radio signals to the User Segment and the Control Segment. The satellites send two types of signal, namely a PPS (Precise Positioning Service Signal) signal which is an encrypted signal for military use only and an SPS (Standard Positioning Service) signal which is an unencrypted signal for non-military general use. The nominal GPS operational constellation consists of 24 satellites that orbit the earth in 12 hours. The satellite orbits have an altitude of 20,200 km and an inclination of 55 degrees with respect to the equatorial plane. There are six orbital planes (with nominally four satellites in each), equally spaced (60 degrees apart). The satellite orbits repeat almost the same ground track once each day (4 minutes earlier each day).

The satellites transmit two microwave carrier signals at an L1 frequency (1575.42 MHz) which carries the code signals for use in the general civilian applications and at an L2 frequency (1227.60 MHz). Each satellite transmits at the L1 frequency a spread spectrum signal containing a BPSK (Bi-Phase Switched keyed) signal in which individual data bits are represented by reversal of the phase of the carrier. This signal is transmitted at a “chipping rate” of 50 bits per second and is called the ‘C/A’ (Coarse Acquisition) signal. This signal contains data in two important fields, namely the almanac and the ephemeris. The almanac contains information about all of the satellites in the constellation. This information is regularly updated from ground stations in the Control Segment monitoring the system but the almanac data remains useful for about one year. The ephemeris contains short-lived information about the constellation and the particular transmitting satellite. Its information is updated by the GPS Control Segment every four hours.

There is a different PRN (pseudo random noise) code included in the C/A code for each satellite. GPS satellites are identified by their PRN number, the unique identifier for each PRN code.

From the ephemeris and almanac information in a signal received from a GPS satellite, a GPS receiver can determine just how long it took the transmitted signal to reach the receiver. That time is proportional to the distance the signal travelled from the satellite to the receiver (its range) so that time can be used to determine an arc on which the receiver must lie. Calculating the intersection point of a number of such arcs derived from different satellites provides a solution to the receiver's location or position on the surface of the earth. The GPS receivers therefore receive signals from either three or four satellites at a time and triangulate a location fix using the time interval between the transmission and reception of each satellite signal. Any given receiver tracks more satellites than are actually needed for a location fix. The reason for this is that if one satellite becomes unavailable, the receiver knows exactly where to find the best possible replacement. Three satellites are required for two dimensional location determination. Two dimensional location reports position based on latitude and longitude only. Four satellites are required for three dimensional location, that is to say latitude, ongitude and elevation (altitude).

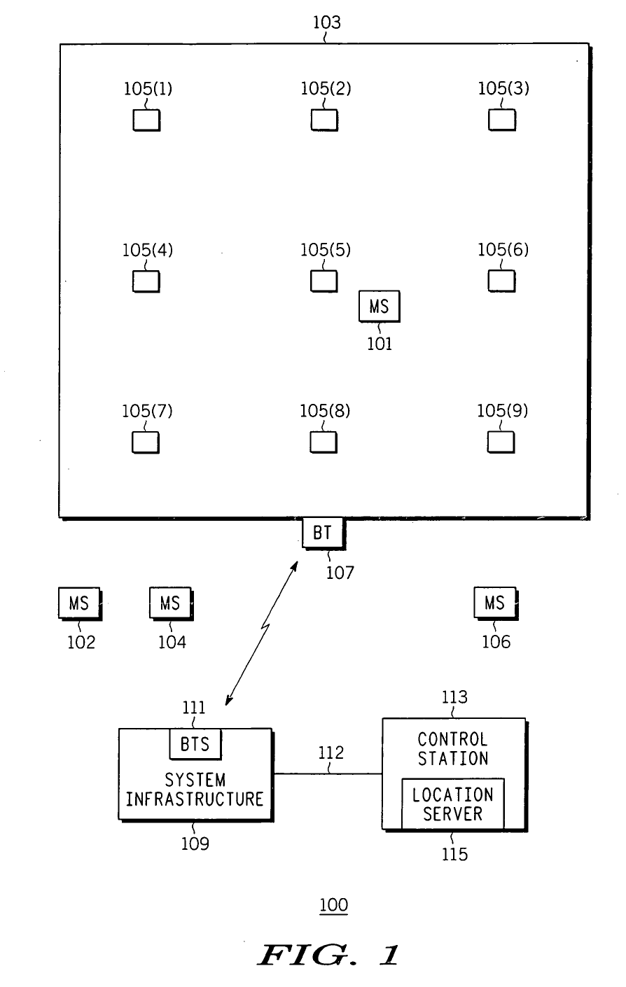

FIG. 1 of the accompanying drawings is a diagram showing a schematic layout of a system 100 embodying the invention for determining location in three dimensions of a MS (mobile station) 101 within a large building 103. Radio beacons 105(1) to 105(9) are fixed in the building 103 in locations of known pre-recorded latitude, longitude and elevation or altitude (e.g. indicating storey number of a multi-storey building). Using nine beacons as in the system 100 shown in FIG. 1 is illustrative only. In principle, any number of beacons may be used. In particular, in a very large building or other enclosure the number of beacons could be much greater than nine.

The beacons 105(1) to 105(9) transmit radio signals in a manner to be described later. The signals can be picked up and processed by the MS 101 inside the building 103 in a manner to be described later. A BT (base transceiver) 107 is fixed to the outside of the building 103 and is able to communicate by radio with mobile stations including the MS 101 inside the building 103 and is also able to communicate by radio with other terminals outside the building 103, particularly with a system infrastructure 109 via a BTS (base transceiver station) 111 included in the system infrastructure 109. The BT 107 is an optional component and could for example be replaced by a mobile station or dispensed with.

The system infrastructure 109 routes and manages radio communications to and from mobile stations operating within the system 100, including the MS 101 inside the building 103 and other mobile stations 102, 104 and 106 outside the building 103. The communication system comprising the infrastructure 109 and the mobile stations 101, 102, 104 and 106 may operate as a trunked communication system according to a known industry protocol standard, e.g. APCO 25 or TETRA. A control station 113 is linked to the system infrastructure 109 by a link 112, which may be a RF link or a hardwired cable link or other known form of link. The control station 113 is an operational control centre attended by one or more operational control managers who provide operational instructions to users of mobile stations operating within the system 100, e.g. the MSs 101, 102, 104 and 106. For example, the users of these MSs may be police officers and the control station 113 may be a police control centre. Radio communications between the control station 113 and the MSs 101, 102, 104 and 106 are sent via the system infrastructure 109 including the BTS 111. The control station 113 includes a location server 115 which receives and sends via the system infrastructure 109 information relating to current location of the MSs 101, 102, 104 and 106, and which processes, manages and stores such information and related information such as the known locations of the beacons 105(1) to 105(9). The server 115 acts as a correlator to correlate identities of the beacons 105(1) to 105(9) with data relating to known locations of the beacons 105(1) to 105(9).

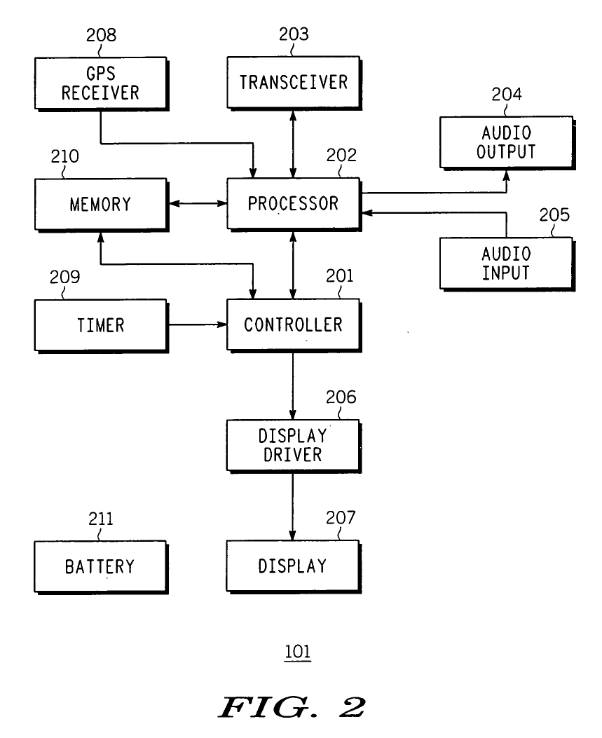

FIG. 2 is a block schematic diagram showing more detail of the MS 101. The other MSs shown in FIG. 1, namely the MSs 102, 104 and 106 are constructed and operate in the same way as the MS 101. The main operations of the MS 101 are controlled by a controller 201 which operates in conjunction with a timer 209 which synchronises operations and a memory 210 which stores data and programs used within the MS 101. A processor 202 processes information to be included in RF signals sent and received by a transceiver 203. The processor 202 extracts information, e.g. electrical signals representing speech signals, from a received RF signal detected by the transceiver 203 and passes the information to an audio output 204 which is a transducer such as a speaker which converts the information to an output audible form for delivery to a user. An audio input 205 is a transducer which converts an input audio signal, e.g. in the form of speech, into an electrical form. The electrical signal is delivered to the processor 202 in which it is processed for sending in a RF signal by the transceiver 203. A display 207 operated by a display driver 206 under control of the controller 201 provides displayed information to a user of the MS 101 in a known manner. A battery 211 provides operation power to all operational components of the radio 101.

The transceiver 203 provides RF communications to and from other transceivers operating within the system 100 such as the BT 107 and the BTS 111 and, when able to operate in a direct communication mode with the MS 101, the MSs 102, 104 and 106. The MS 101 also includes a GPS receiver 208 which can receive GPS signals from GPS satellites (not shown) when the MS 101 is outside the building 103 or can receive pseudo GPS signals from one or more of the beacons 105(1) to 105(9) (in a manner described in more detail later) when the MS 101 is inside the building 103 as shown in FIG. 1. Information extracted by the GPS receiver 208 is passed to the processor 202 to be processed in a manner to be described later.

The beacons 105(1) to 105(9) serve as partially coded pseudo GPS transmitters. The signal transmitted by each of the beacons 105(1) to 105(9) is at the GPS L1 carrier frequency referred to earlier and is modulated with an identity code equivalent to the PRN satellite identifier included in the C/A code of a GPS signal explained earlier. The exact three dimensional location (latitude, longitude and altitude) of each of the beacons 105(1) to 105(9) is, as noted earlier, already known in the system 100 and can for example be stored in the server 115 or even in the memory 210 of the MS 101. This location data for any of the beacons 105(1) to 105(9) can easily be retrieved if the identity code of the beacon in question is obtained from the coded signal transmitted by the beacon. The MS 101 can obtain this identity code by receiving the signal from a given beacon 105(1) to 105(9) at the GPS receiver 208 (FIG. 2).

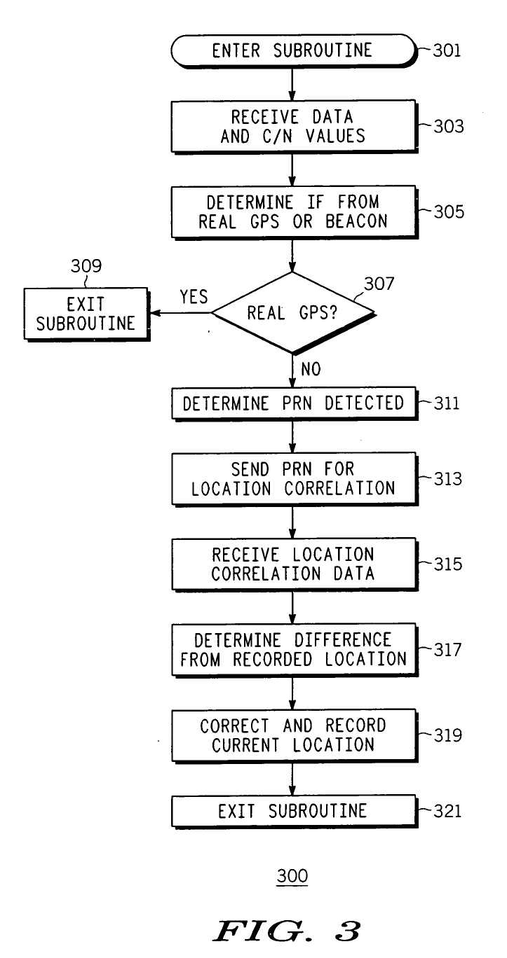

The signal transmitted by each of the beacons 105(1) to 105(9) contains null ephemeris and almanac data as usually embodied in a GPS signal from a GPS satellite. The loading of data into the signal to be transmitted by each of the beacons 105(1) to 105(9) is therefore considerably simplified. However, the lack of the ephemeris and almanac data does not prevent the identity of the beacon 105(1) to 105(9) being extracted from the signal received at the GPS receiver 208. Thus the GPS receiver 208 extracts the beacon identity data but null ephemeris and almanac data and passes the data to the processor 202. It is to be noted that the GPS receiver 208 does not compute location using the signals from the beacons 105(1) to 105(9). It merely provides output data to the processor 202 which the processor 202 uses in the manner described later with reference to FIG. 3.

The GPS receiver 208 of the MS 101 accepts the GPS signal from any appropriate beacon 105(1) to 105(9) and determines a signal to noise level of the signal within a 1 Hz bandwidth, which is referred to as ‘C/N’ (carrier to noise) value of the signal. The GPS receiver 208 delivers to the processor 202 C/N values assigned to signals from beacons 105(1) to 105(9) whose identity data is delivered. Only the beacon whose signal shows the best C/N value, as reported through the standard operating protocol (‘NMEA’) of the GPS receiver 208, is chosen by the processor 202. This strongest signal comes from the closest beacon 105(1) to 105(9). The identity of the closest beacon is used further in the procedure described later with reference to FIG. 3. It is to be noted that the beacon that is currently closest, e.g. the beacon 105(5) as shown in FIG. 1, can change as the MS 101 moves about inside the building 103.

The time derivative of the C/N values received by the processor 202 can be determined by the processor 202 to provide direction and range characteristics for additional accuracy enhancements.

The C/N values can be established for any combination of signals from the beacons 105(1) to 105(9) by the GPS receiver 208. This can be used beneficially in the following enhancement. Each one of the beacons 105(1) to 105(9) can transmit signals which mimic signals from any combination of GPS satellites up to the entire constellation of GPS satellites rather than from a single GPS satellite. For example, if the codes equivalent to Satellites 7 and 11 of the GPS are transmitted by the beacon 105(1), then when the two codes are detected together in the data passed to the processor 202, the beacon 105(1) can be identified by the processor 202 from the particular combination. The benefit of this enhancement is to improve the probability of accurate beacon identity determination and to improve coverage in a building without using an unduly large number of beacons. By mapping different areas in a building to various combinations of transmitted codes we can minimize the number of such beacons needed to map the whole building. For example, using different combinations each of two codes selected from a set of 36 codes to define each of a number of areas to be mapped in a building or enclosure it is possible to produce 630 different two code combinations. However, the number of zones to be covered is unlikely to be greater than 100, unless for example the structure to be covered is an underground mine or the like. Thus, in general any number of permutations and combinations of codes mimicking GPS satellite PRN codes may be used to divide a building or enclosure into the required number of zones within the physical building limitations, such as dimensions and number of storeys, while aiming eventually to provide satisfactory system performance with minimized system cost.

FIG. 3 is a flowsheet showing a sub-routine (procedure) 300 operated by the processor 202 shown in FIG. 2. The processor 202 enters the sub-routine 300 at a step 301. In a step 303 the processor 202 receives data and C/N values from the GPS receiver 208 as described earlier. In a step 305 the processor 202 determines if the data and C/N values are from a real GPS satellite or from a beacon such as one of the beacons 105(1) to 105(9). It does this by recognizing the identity code received as being associated with one of the beacons 105(1) to 105(9) and/or by detecting that the received signal(s) contains no ephemeris and/or almanac data.

Using the results of the determination carried out in step 305, the processor 202 decides in a decision step 307 whether or not the received signal(s) is from a real GPS satellite or from a beacon. If the processor 202 decides that the signal(s) is from a real GPS satellite no further processing is needed by the processor 202 to determine location and the processor exits the subroutine 300 at a step 309. If the processor 202 decides that the signal(s) is not from a real GPS satellite, the subroutine 300 continues to a step 311 in which is detected the PRN identity of the nearest beacon to the MS 101, e.g. the beacon 105(5) as shown in FIG. 1. This is done by reference to the best C/N value obtained. In a step 313 the identity of the nearest beacon, e.g. the beacon 105(5), is sent by the processor 202 for location correlation. A signal is sent via the transceiver 203, the BT 107 and the BTS 111 to the control station 113 and is applied to the location server 115. The server 115 acts as a correlator by retrieving the three dimensional location co-ordinates of the identified beacon that were recorded upon deployment of the beacon system and sends the co-ordinate correlation data back to the processor 202 via the BTS 111, BT 107 and transceiver 203. The processor 202 receives the beacon location co-ordinates which correlate with the identified nearest beacon in a step 315.

In a step 317 the processor 202 determines a difference in location of the identified beacon from a last previously recorded location stored in the memory 210 and in a step 319 the processor 202 corrects and records in the memory 210 the current location using the difference data. The last previously recorded location which the processor 202 uses in step 317 is either the last location recorded using real GPS data or a modified in-building location found by correcting the last real GPS obtained location using one or more earlier iterations of the sub-routine 300. After step 319 has been completed, the processor 202 exits the subroutine 300 in a step 321.

The current location determined by the subroutine 300 is of course an approximation and the accuracy of the approximation depends on how near the MS 101 is to the nearest beacon 105(1). The current location data obtained may be used by the MS 101 in any of the known ways in which location data obtained using the real GPS is used by a mobile station. Thus, the data may be displayed to the user of the MS 101 on the display 207 in the form of text or graphical information, and/or may be transmitted by a radio signal sent by the transceiver 203, e.g. via the BT 107 to one or more other MSs, e.g. the MSs 102, 104 and 106, or to the control station 113 via the BTS 111.

Thus, the system 100 shown in FIG. 1 provides the benefits of the in-building beacon location systems of the prior art but beneficially with a reduced complexity and cost. As with the known pseudolite system, the receivers employed in the mobile stations embodying the invention may beneficially comprise commercially available GPS receivers. However, in contrast to the beacons used in the known systems, each of the radio beacons 105(1) to 105(9) in the system 100 embodying the invention can be a relatively simple piece of hardware programmed to transmit one or more pseudo GPS signals (each of) which is only partially coded with sufficient data to enable the identity of the beacon to be extracted by a GPS receiver. Another benefit of the system 100 embodying the invention is that a signal from only one of the beacons 105(1) to 105(9) is needed as a minimum to estimate the current location of a mobile station. This is in contrast to the known pseudolite system in which at least three or four signals from different beacons are needed.

What is claimed is:

1. A radio beacon for use in location determination inside a building or other enclosure, the beacon being operable to transmit a RF signal equivalent to a partially coded GPS (Global Positioning System) signal which includes an identity code identifying the beacon but null data in at least one GPS data field, the signal being capable of reception by a GPS receiver.

2. A beacon according to claim 1 which is operable to transmit a signal which includes null data in the GPS ephemeris field or almanac field or both.

3. A beacon according to claim 1 which is operable to transmit a signal equivalent to a partially coded GPS (Global Positioning System) signal at the GPS L1 frequency, the signal carrying a code equivalent to the GPS Coarse Acquisition code including a pseudo random noise (PRN) identity code identifying the beacon.

4. A beacon according to claim 1 wherein the beacon is operable to transmit a combination of signals identifying the beacon.

5. A system for use in the determination of location of a mobile station in a building or other enclosure including a plurality of radio beacons each operable to transmit a RF signal equivalent to a partially coded GPS (Global Positioning System) signal which includes an identity code identifying the beacon but null data in at least one GPS data field, the signal being capable of reception by a GPS receiver, and at least one mobile station including a GPS receiver operable to receive a signal from one of the beacons and a processor operable to process data extracted from the received signal to recognise the beacon identity code from the data extracted.

6. A system according to claim 5 including a mobile communication system including a plurality of mobile stations and an infrastructure via which the mobile stations are operable to communicate, each of the mobile stations including a GPS receiver operable to receive a signal from one of the location beacons and a processor operable to process data extracted from the received signal to recognise the beacon identity code from the data extracted.

7. A system according to claim 6 including a control station for receiving from the mobile stations information relating to their respective current locations.

8. A system according to claim 7 wherein the control station is operable to receive from each of the mobile stations beacon identity data obtained from a signal from a radio beacon when the mobile station is in the vicinity of the beacon and to correlate the data with pre-recorded location co-ordinates for the identified beacon and optionally to send the co-ordinates to the mobile station.

9. A mobile station including a receiver for receiving GPS (Global Positioning System) signals and a processor for processing data extracted from a received GPS signal, the receiver being operable to receive from a transmitting beacon a RF signal equivalent to a partially coded GPS signal which includes a beacon identity code identifying the transmitting beacon but null data in at least one GPS data field and the processor being operable to recognise the beacon identity code from the data extracted.

10. A mobile station according to claim 9 wherein the processor is operable to detect whether a received signal is from a GPS satellite or from a radio beacon and to process the signal by a further procedure only if the signal is detected to be from a radio beacon.

11. A mobile station according to claim 10 wherein the processor is operable to detect that a received signal is from a radio beacon by recognising a form of the identity code extracted.

12. A mobile station according to claim 10 wherein the processor is operable to detect that a received signal is from a radio beacon if no data is present in at least one GPS data field.

13. A mobile station according to claim 12 wherein the processor is operable to detect that a received signal is from a radio beacon if no data is present in the GPS ephemeris data field or the GPS almanac field or both.

14. A mobile station according to claim 9 wherein the processor is operable to apply a step which includes determining which of a plurality of signals received from a plurality of radio beacons is a strongest signal.

15. A mobile station according to claim 9 wherein the processor is operable to apply a step which includes sending an identity code associated with the radio beacon providing the strongest received signal to a correlator to correlate the identity code with pre-recorded location data for the beacon.

16. A mobile station according to claim 15 wherein the processor is operable to apply a step which includes receiving from the correlator location data for the radio beacon providing the strongest received signal.

17. A mobile station according to claim 9 wherein the processor is operable to apply a step which includes retrieving data relating to a previous location of the mobile station and correcting the data to provide a current calculated location using data relating to the location of an identified beacon.

18. A mobile station according to claim 9 wherein the processor is operable to calculate a time derivative of a signal to noise ratio of a received signal.

19. A mobile station according to claim 9 which further comprises a radio transceiver for communication with other radio terminals.

20. A mobile station according to claim 19 wherein the radio transceiver is operable to send radio communications containing information relating to identified beacons and/or current location of the mobile station.

21. A processor operable as the processor of the mobile station claimed in claim 9.
